(19) United States
(12) Patent Application Publication
(10) Pub. No.: US 2009/0321341 A1
(43) Pub. Date: Dec. 31, 2009

(54) FILTER SYSTEM FOR FLUIDS

(76) Inventor: Norbert Sann, Riegelsberg (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/309,677

(22) PCT Filed: Jun. 14, 2007
(86) PCT No.: PCT/EP2007/005235

§ 371 Date: Jan. 27, 2009

(30) Foreign Application Priority Data
Jul. 28, 2006 (DE) 10 2006 034 943.1

(51) Int. Cl. B01D 35/30

(52) U.S. Cl. 210/233; 210/232

(57) ABSTRACT

A filter system for fluids having a fluid vessel (3), especially in the form of a hydraulic tank, and a filter element (1) which can be installed into it and has a fluid-permeable support tube (23) which is surrounded by a filter medium (27) and forms an inner fluid space (21) which is closed at one end by an end cap (39), the support tube (23) being fixable at its other, open end at the edge of an access orifice (5) of the fluid vessel (3), is characterized in that a centering part (41) is present at the end cap (39) of the filter element (1) and in that a positioning part (13) is connected to the wall of the fluid vessel (3) and, interacting with the centering part (41) of the end cap (39), centers the filter element (1) installed into the fluid vessel (3).

The invention relates to a filter system for fluids having a fluid container, in particular in the form of a hydraulic tank, and a filter element which can be installed therein and which has a fluid-permeable support tube which is surrounded by a filter medium and which forms an inner fluid space which on one end is closed by an end cap, the support tube on its other, open end being fixable on the edge of an access opening of the fluid container.

These filter systems are commercially available in a plurality of designs and versions. They are used among other things to filter dirt from fluids such as hydraulic oil. Fouling of hydraulic oil occurs in installation and in start-up of the respective hydraulic system, and in addition to this initial fouling, fouling can occur during operation, for example, by the penetration of dirt on the hydraulic tank due to insufficient tank ventilation, pipe feedthroughs, piston rod seals, and the like. If fouling occurs within the fluid stored in the hydraulic tank in hydraulic systems of machines, such as earth moving machines, excavators, or the like, it can be advantageous to undertake filtration directly in the region of the hydraulic tank, for example, by installing the filter element directly in the tank, the hydraulic oil which has been removed from the tank contents flowing directly through the filter medium of the filter element to filter out the dirt and the fluid which has been cleaned in this way being returned to the tank contents. In these solutions the filter systems merely cleans the tank contents. But solutions are also conceivable in which the filter system delivers the respectively filtered and cleaned fluid to the hydraulic circuit of the machine, in order to return from there to the tank the fluid which can also be fouled with solid parts in this circulation in the hydraulic circuit.

For satisfactory operating behavior of these filter systems, several prerequisites must be met. On the one hand, with respect to adequate operating reliability, in particular also under dynamic loads (vibrations), reliable positioning of the filter element within the tank must be ensured. On the other hand, in the interests of ease of maintenance, the replacement of used filter elements must be easily and conveniently possible. In the known filter systems the contradictory requirements, specifically sufficiently reliable anchoring of the filter element and easy and convenient interchangeability, are not satisfied at the same time. In the known solutions, when the filter element is changed, tedious and time-consuming measures in conjunction with dismounting and mounting of anchoring means for the filter element must be carried out.

With respect to these problems, the object of the invention is to make available a filter system in the form of a so-called in-tank system, in which, in spite of perfect positioning of the filter element, its replacement can be implemented easily and conveniently and the filter system, moreover, is characterized by an especially simple design which can be economically produced.

According to the invention, this object is achieved by a filter system which has the features of claim 1 in its entirety.

Accordingly, one important particular of the invention consists in that in the interaction between a centering part on the end cap of the filter element and a positioning part, which is connected to the wall of the fluid container, a centering on the face side of the filter element is formed. Thus, engagement between the centering part and positioning part can take place by inserting the filter element through the access opening and by releasing the centering engagement by removing the filter element from the access opening. The face centering of the filter element on the end cap, i.e., on the end of the support tube which is opposite the access opening, in interaction with the fixing of the orifice-side end of the support tube, which fixing is provided on the access opening, yields reliable fixing in position, i.e., reliable holding of the filter element even under the dynamic loads which may occur. In spite of the simple design, due to the anchoring which is simple to establish and release in replacement processes of the filter element, this invention offers the advantage of simplified maintenance.

In especially advantageous embodiments in which the fluid container is molded out of a plastic material, the positioning part can be formed by deformation of the wall of the fluid container. Such embodiments are especially simple and economical to produce, for example, by the container being produced in a blow molding process or according to the known rotational molding process, and, for larger containers such as tanks for hydraulic liquid, for example, PE or PA plastic material can be used.

In embodiments in which the centering part is formed by a depression of the end cap of the filter element, and to form the positioning part, the wall of the fluid container has a deformation in the form of a cup whose bottom together with the bordering side walls forms a peg which projects into the interior of the container for centering engagement to a depression, for an extremely simple design especially reliable anchoring of the filter element is ensured.

These embodiments are moreover characterized by especially great ease of operation when the arrangement is such that the peg in its end section located within the container has a bevel which reduces the peg diameter. In this way, without special attention having to be focused thereon, when the filter element is slid into the container, reliable centering engagement takes place when the end cap of the filter element is moved to the beveled peg.

Instead of a centering part which is formed by a depression in the end cap, alternatively the centering part can be formed by a lug-like extension of the end cap of the filter element which has a U-profile section which, in interaction with a rib structure which engages the U profile which projects to the interior on the wall of the fluid container, and which is used as a positioning part, centers the installed filter element.

As in the embodiment described first, in which the end cap forms an edge enclosure for the assigned end of the filter medium, in the second embodiment the extension can be attached to the end edge of the end cap, which edge forms an edge enclosure for the assigned end region of the filter medium.

Analogous to the peg of the first embodiment which is used as the positioning part, the rib structure of the second embodiment which forms the positioning part can also be formed by an integral wall part of the container, and the rib structure can be formed by an elongated wall part of the fluid container which is drawn into the interior of the container and the in-drawn wall part with its exterior in the wall of the fluid container forms a groove which runs in the direction of the rib structure and which is open on the two sides of the fluid container which border one another. In this way, within the container a rib is formed which at a distance from the container bottom extends away from the side wall of the container, that is to say, extends transversely to the direction of insertion of the filter element which has been inserted from the top side of the container.

The subject matter of the invention is also a filter element which has the features of claim 10 for the filter system according to the invention.

The invention is detailed below using embodiments which are shown in the drawings.

FIG. 1 shows a longitudinal section of one embodiment of the filter system according to the invention, drawn slightly schematically simplified;

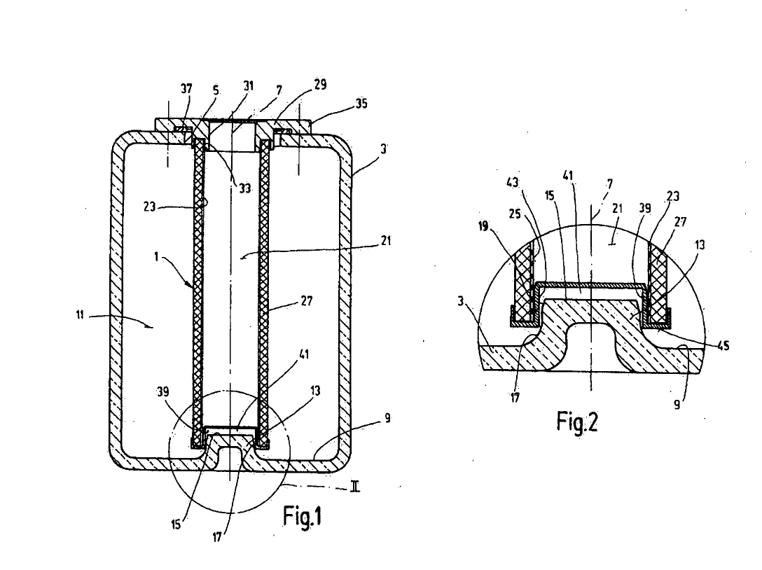

FIG. 2 shows a partial representation of the region designated as II in FIG. 1, greatly enlarged compared to FIG. 1;

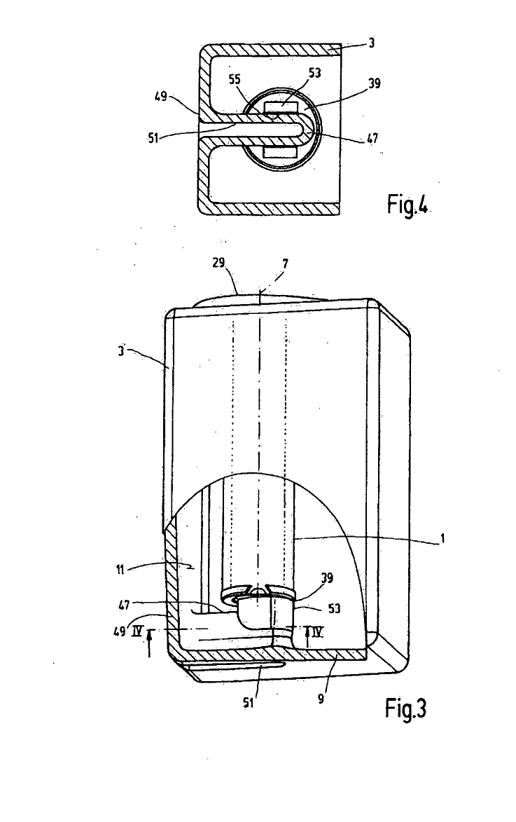

FIG. 3 shows a cutaway and schematically simplified oblique view of a second embodiment of the filter system according to the invention;

FIG. 4 shows a partial section enlarged compared to FIG. 3 according to cutting line IV-IV from FIG. 3;

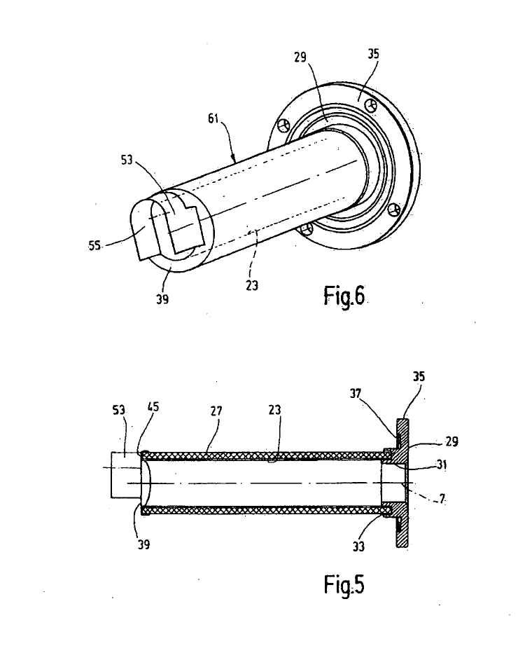

FIG. 5 shows a longitudinal section of only the filter element of the embodiment from FIGS. 3 and 4, drawn slightly schematically simplified,

FIG. 6 shows a perspective oblique view of the filter element which is drawn slightly enlarged compared to FIG. 5.

In the drawings, FIGS. 1 and 2 show a first embodiment of the filter system according to the invention in the form of a so-called in-tank filter system, in which a filter element which is designated as a whole as 1 is installed in the hydraulic tank 3. It is a plastic tank which is produced according to the known rotational molding process (cf. Schaab/Stoeckert, Kunststoff Maschinenführer, pp. 561-564) from a plastic material which is suitable for larger containers, on the top side an access opening 5 being formed in the process of rotational molding. In the illustrated example, the access opening 5 is concentric to a central major axis 7 (axis of rotation with respect to the molding process). On the bottom 9 of the tank 3 opposite the orifice 5, likewise in the rotational molding process, a peg 13 is formed which projects into the interior 11 of the tank 3, which is concentric to the axis 7, and which has the shape of a cup whose bottom 15 together with the bordering side wall 17 forms a positioning body which is concentric to the axis 7. As is to be seen most clearly from FIG. 2, the side wall 17 of the peg 13 in the end region bordering the bottom 15 has a bevel 19 which reduces the exterior diameter of the peg 13 in the end region.

The filter element 1, as is conventional for such filter means, has a support tube 23 which forms the inner fluid space 21 and which is made of metal or plastic, and as can be seen from FIG. 2, has fluid passages, of which only one is designated as 25 in FIG. 2. The support tube 23 on the exterior is surrounded by the filter medium 27 which has a structure which is conventional for the respective filtration process. On that end of the filter element 1 which is assigned to the access opening 5 when installed in the tank 3, the support tube 23 together with the respective end of the filter medium 27 is connected to the cover 29 of the element. The cover 29 which in this example is a diecast part of aluminum alloy has a central opening 31 for forming a fluid connection which is not shown. On the underside of the cover 29 which is facing the tank interior 11 when installed in the tank 3, the opening 31 is surrounded by a concentric annular groove 33. The latter forms a seat for the pertinent end of the support tube 23 and of the filter medium 27, in the seat there being a connection by means of an epoxy cement. On the exterior the cover 29 forms a flange edge 35 which can be detachably mounted on the exterior of the tank 3, the flange edge 35 forming an enclosure for the sealing element 37.

The end of the filter element 1 opposite the opening 31 is closed by an end cap 39. It is shaped such that a depression 41 is formed which extends into the fluid space 21 whose side wall 43 extends along the interior of the end section of the support tube 23. The part of the end cap 39 which adjoins the side wall 43 of the depression 41 forms an edge enclosure 45 which encloses the support tube 23 and the end of the filter medium 27.

As already mentioned, in the described design the replacement of the filter element 1 is extremely simple, since when the filter element 1 is installed it need simply be pushed through the access opening 5 of the tank 3 simply in the course of the insertion motion and need be slipped onto the peg 13 which is used as the positioning part, engagement being produced between the depression 41 of the end cap 30, which depression acts as the centering part, and the peg 13 which is used as the positioning part. As a result of the bevel 19 which is provided on the end side on the peg 13, reliable centering engagement takes place, even if a certain alignment error should be occur in the insertion process. At the same time, the centering of the filter element 1, which centering is opposite the cover 29, ensures its perfect positioning in the tank, even if the tank 3 is exposed to dynamic loads, such as jolting and vibrations.

FIG. 3 to 6 illustrate a second embodiment. In the drawings, parts of the second embodiment which correspond to those of the first embodiment are designated with the same reference numbers as in the first example. The difference from the first embodiment consists simply in the different design of the centering part which is present on the end cap 39 of the filter element 1 and the correspondingly different configuration of the positioning part on the wall of the tank 3. Instead of the cup-shaped peg 13 which is deformed to the interior on the bottom 9 out of the wall of the tank 3 in the first embodiment, in the second embodiment there is a deformation of the wall of the tank 3 in the form of a rib-like structure 47 (see FIG. 3) which proceeding from the side wall 49 projects into the interior 11 of the tank 3, its forming a rib which runs straight at a distance from the bottom 9. This deformation of the wall of the tank 3 on its exterior forms a narrow depression in the form of a groove 51 which is open on the exterior of the bottom 9 and on the exterior of the side wall 49.

The centering part which can be slipped onto the rib structure 47, on the end cap 39 which on the filter element 1 likewise forms an edge enclosure for the end of the filter medium 11 and of the support tube 23, is an extension 53 which is made in the form of a lug, such that a U-profile section 55 is formed. As can be taken from FIGS. 3 and 4, the extension 53 can be slipped onto the rib-like structure 47 such that centering engagement takes place by engaging the U-profile section 55. As in the above described embodiment, in the example of FIGS. 3 to 6, the process of changing the element is made simple, convenient and reliable by the extension 53 which is used as the centering part being slipped onto the rib-like structure 47 which is used as the positioning part when the filter element 1 is inserted through the access opening 5 of the tank 3. Centering engagement leads to the desired positioning of the filter element 1 in the interior 11 of the tank 3. The extension 53 can be molded in one piece onto the end-cap 39 or can be connected as a separate part to the end cap 39, for example, by an epoxy cement.

1. A filter system for fluids having a fluid container (3), in particular in the form of a hydraulic tank, and a filter element (1) which can be installed therein and which has a fluid-permeable support tube (23) which is surrounded by a filter medium (27) and which forms an inner fluid space (21) which on one end is closed by an end cap (39), the support tube (23) on its other, open end being fixable on the edge of an access opening (5) of the fluid container (3), characterized in that on the end cap (39) of the filter element (1) there is a centering part (41; 53) and that the wall of the fluid container (3) is connected to a positioning part (13; 47) which centers the filter element (1) which has been installed in the fluid container (3) in interaction with a centering part (41; 53) of the end cap (39).

2. The filter system according to claim 1, characterized in that the fluid container (3) is molded out of a plastic material and that the positioning part (13; 47) is formed by deformation of the wall of the fluid container (3).

3. The filter system according to claim 2, characterized in that the centering part is formed by a depression (41) of the end cap (39) of the filter element (1) and that to form the positioning part the wall of the fluid container (3) has a deformation in the form of a cup whose bottom (15) together with the bordering side wall (17) forms a peg (13) which projects into the interior (11) of the container for centering engagement to a depression (41) of the end cap (39).

4. The filter system according to claim 3, characterized in that the side wall (43) of the depression (41) in the end cap (39) is formed by a wall section of the latter which extends from the end edge of the support tube (23) along its interior axially into the fluid space (21).

5. The filter system according to claim 4, characterized in that the part of the end cap (39) which is connected to the side wall (43) of the depression (41) forms an edge enclosure (45) which encloses the filter medium (27) on its end and in the end region of its exterior.

6. The filter system according to claim 3, characterized in that the peg (13) in its end section which is located in the interior (11) of the container has a bevel (19) which reduces the peg diameter.

7. The filter system according to claim 1, characterized in that the centering part is formed by a lug-like extension (53) of the end cap (39) of the filter element (1), which extension has a U-profile section (55) which, in interaction with a rib structure (47) which engages the U-profile (55) which projects to the interior on the wall of the fluid container (3) and which is used as a positioning part, centers the installed filter element (1).

8. The filter system according to claim 7, characterized in that the extension (53) is attached to the end edge of the end cap (39), which edge forms an edge enclosure for the assigned end region of the filter medium (27).

9. The filter system according to claim 7, characterized in that the rib structure (47) which forms the positioning part is formed by an elongated wall part of the fluid container (3) which is drawn into the interior (11) of the container, the in-drawn wall part with its exterior in the wall of the fluid container (3) forming a groove (51) which runs in the direction of the rib structure (47) and which is open on the two sides of the fluid container (3) which border one another.

10. The filter element for a filter system according to claim 1, with a fluid-permeable support tube (23) which is surrounded by a filter medium (27) and which forms an inner fluid space (21) which on one end is closed by an end cap (39), the support tube (23) on its other, open end being fixable on the edge of an access opening (5) of the fluid container (3), and on the end cap (39) there being a centering part (41; 53) in order to form centering of the filter element (1) which is held in the fluid container (3) in interaction with a positioning part (13; 47) which is connected to the wall of the fluid container (3).
